(19) United States
(12) Patent Application Publication
(10) Pub. No.: US 2004/0027821 A1
(43) Pub. Date: Feb. 12, 2004

(54) Pyrazolone lanthanide complexes

(76) Inventors: Jonathan Nigel Gerard Pillow, Oxford (GB); Victor Christou, Oxford (GB); Mark Etchells, Cheshire (GB); Alan Mosley, Berkhamsted (GB)

Correspondence Address: Carl R Schwartz, Quarles & Brady, Suite 2040, 411 East Wisconsin Avenue, Milwaukee, WI, 53202-4497, US

(21) Appl. No.: 10/363,206

(22) PCT Filed: Sep. 7, 2001
(86) PCT No.: PCT/GB01/04019

(30) Foreign Application Priority Data
Sep. 8, 2000 (GB) 0022081.4

(51) Int. Cl. F21V 9/16

(52) U.S. Cl. 362/84

(57) ABSTRACT

Photoluminescent compounds are described having no-ligand. These have formula (I) in which Ln represents a lanthanide ion, each of X, Y, and Z, which may be the same or different, represents hydrogne, an optionally substituted aromatic group or an optionally substituted aliphatic or cycloaliphatic group, such that at least one of X, Y and Z represents a said aromatic group which is conjugated with the pyrazolone ring system and such that when X or Y represents a said group, said group can optionally be attached via a hetero atom. These compounds possess useful electroluminescent properties such that they can be used in electroluminescent devices.

The present invention relates to pyrazolone lanthanide complexes suitable for use in light emitting devices.

The electroluminescence properties of organolanthanide complexes have been known for several years. These compounds contain a positively charged central lanthanide ion, for two or more organic anions and, in many cases, a neutral co-ligand.

More recently, terbium complexes formed from 4-substituted 1-phenyl-3-methyl-5-pyrazolone have been widely reported and have been shown to produce good electroluminescent properties. The general structure of these terbium complexes consists of a Tb³⁺ ion, three monovalent 1-phenyl-3-methyl-5-pyrazolone anions and at least one co-ligand molecule, which become attached to the terbium ion during the synthesis of the material or through subsequent treatment.

A range of co-ligands has been reported, e.g. triphenyl phosphine oxide, bipyridine, phenanthroline, alcohols and water. The precise role of the co-ligand in the electroluminescence of these materials is not well understood, but their presence is generally thought to be advantageous. However, we have found, according to the present invention, that their presence can lead to poor reproducibility of the electroluminescence of devices. For example, some co-ligands, e.g. triphenyl phosphine oxide, are not strongly bound to the terbium which makes it very difficult to purify the final material, because normal treatment, eg. recrystallisation, vacuum sublimation/evaporation and chromatography can lead to a partial loss of the co-ligand. The difficulty in purifying the material can lead to non-reproducible electroluminescent results.

There has also been some suggestion that the co-ligand may quench the electroluminescence of the terbium ion by accepting the transfer of electrons from the excited state of the ligand before they can be transferred to the terbium ion. Furthermore, some co-ligands, e.g. 1,10-phenanthroline, can interfere very strongly with the electroluminescent process by forming an excited state which leads to, for example, orange/white light emission from an exiplex rather than the emission of green light from the terbium ion.

According to the present invention we provide lanthanide complexes of pyrazolones which do not contain any co-ligands. Accordingly, the present invention provides a compound of the formula

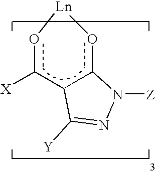

in which Ln represents a trivalent lanthanide ion, each of X, Y and Z, which may be the same or different, represents hydrogen, an optionally substituted aromatic group or an optionally substituted aliphatic or cycloaliphatic group, such that at least one of X, Y and Z represents a said aromatic group which is conjugated with the pyrazolone ring system and such that when X or Y represents a said group, said group can optionally be attached via a hetero atom. Thus the only ligand is the specified pyrazolone ligand.

Typically, the compound contains one or two aromatic groups which conjugate with the pyrazolone ring system. The aromatic groups generally have 5 to 7 ring members, especially 5 or 6. Thus the aromatic group is optionally substituted phenyl. The aromatic group can also be polycyclic such as biphenyl to 6 carbon atoms such as methyl.

In a preferred embodiment Z represents such an aromatic grouping.

The, or one of the, aliphatic grouping is typically an (lower) alkyl group of 1 to 4 carbon atoms such as methyl or isopropyl or an (higher) alkyl group which has at least 4 carbon atoms, for example 4 to 20, typically 4 to 8 or 10, carbon atoms such as secondary butyl and 3-pentyl. It is preferred that the, or one of the, aliphatic groups is branched and has a backbone of not more than 6 carbon atoms. Preferably it has 2 branches at the attachment position as in isopropyl or 4-heptyl, or 2 or 3 branches further down the chain e.g. as in 2,2-dimethyl propyl. If Z represents an aromatic grouping then it is preferred that at least one of X and Y is an aliphatic grouping or one represents an aliphatic group and the other represents an aromatic group. Preferably one of X and Y, especially Y, is an alkyl group of 1 to 4 carbon atoms while the other, especially X, is a larger group i.e. an alkyl group of at least 4 carbon atoms or an aryl group.

The aliphatic groupings can be substituted for example by fluorine, as in trifluoromethyl and heptafluoropropyl, although in general it is preferred that the substituent is electron donating, for example, the aliphatic grouping can be connected via a hetero atom to the molecule, typically a nitrogen, sulphur or oxygen atom, such that the substituent is alkoxy, aliphatic amino or alkyl thio. Specific examples of such groupings include ethoxy and dimethyl amino. The aromatic grouping can also be connected via a hetero atom as with diphenylamino.

The aliphatic substituent can also be cyclic, typically with 5 to 7 carbon atoms, such as cyclohexyl, which can be substituted, typically by an alkyl group having 1 to 6, especially 1 to 4, carbon atoms such as methyl or butyl as in 2-methylcyclohexyl, 4-methylcyclohexyl and 4-tertiarybutylcyclohexyl.

It will also be appreciated that, in general, when Z represents an aliphatic or aromatic group it cannot be attached via a hetero atom.

It will be appreciated that, in some compounds, more than one isomer is possible. The present invention includes both optically active and racemic mixtures. For example, when X represents an aliphatic grouping such as 2-butyl, two isomers are possible.

In the preferred compounds of the present invention X represents an optionally substituted aliphatic or cycloaliphatic group, Y represents an alkyl group of 1 to 4 carbon atoms and Z represents an optionally substituted aromatic group which is conjugated with the pyrazolone ring system.

Ln represents any trivalent lanthanide ion. Specific examples include lanthanum, europium, terbium, gadolinium, dysprosium and samarium but preferably it is terbium or dysprosium.

The compounds of the present invention can be prepared simply by subliming/evaporating a corresponding compound which contains a co-ligand which readily disassociates on sublimation. Naturally, the nature of the co-ligand will vary with the nature of the lanthanide but it is typically 2,2′-bipyridyl. The co-ligand must be labile enough to dissociate on sublimation but be able to displace solvent from the co-ordinating position since solvent co-ligands can be difficult to remove. Apart from bipyridyl and its derivatives, other suitable ligands include phenanthroline and its derivatives, quinoxalines, pyridines, terpyridines, phosphine oxides such as triphenylphosphine oxide, sulphoxides and N-oxides as well as tetraalkylethylenediamines of general formula R₂NCH₂CH₂NR₂ and tetraalkylethylenediphosphines of the general formula R₂PCH₂CH₂PR₂ where each R, which may be the same or different, represents an alkyl group.

In many cases the product of a single sublimation will not be free of the co-ligand and it is preferred that the compound is obtained substantially free of the corresponding compound which possesses a co-ligand. Two or more sublimations may therefore be needed. Indeed, in some cases, it is very difficult to remove the co-ligand. For example the 2,2′-bipyridyl complex where X is CF₃CF₂CF₂, Y is methyl and Z is phenyl does not lose 2,2′-bipyridyl on sublimation. One of skill in the art should therefore select the substituents with this in mind.

The photoluminescence and the electroluminescence of the compound will, of course, vary with the nature of the substituents. In addition, though, the ease of purifying the compound will also vary with the substituents. For example, for compounds where Z represents phenyl and Y represents methyl, in the case where X represents tertiary butyl the compound sublimes well but does not have a particularly good photoluminescent (PL) emission, but if X represents isopropyl the compound does have good PL emission but it melts and decomposes during the evaporation unless great care is taken to control the temperature and rate of evaporation. Accordingly, it is preferred that the compound should evaporate or sublime before it decomposes. This can generally be achieved by increasing the chain length of at least one of the substituents X or Y such that it has at least 4 carbon atoms. It is believed (although this does not form part of the present invention) that the bulky tertiary butyl substituent forces the complex to twist out of plane slightly. This lowers the triplet energy level so that the triplet level is not as well matched to the Tb energy level as in the corresponding isopropyl complex. It is preferred that the aliphatic chain is branched but not tertiary at the attachment position so as to avoid steric hindrance. In general, the triplet energy level should be at least 2500 wave numbers above the first excited state of the lanthanide ion. It will be appreciated that the triplet energy level will be affected by the presence or absence of electron withdrawing or electron donating groups.

As indicated above, the compounds can be obtained by sublimation of the corresponding compounds with a co-ligand including 2,2′-bipyridyl and the other ligands mentioned above. Alternatively, it is possible to dehydrate the corresponding hydrated compounds, for example using Soxhlet extraction apparatus in which the thimble is loaded with a drying agent such as CaH₂ and the compound is dissolved in a high boiling solvent such as toluene or chlorobenzene.

The compounds with the co-ligand can be obtained in a conventional manner. In general the pyrazolone ligand can be obtained in accordance with the following reaction scheme

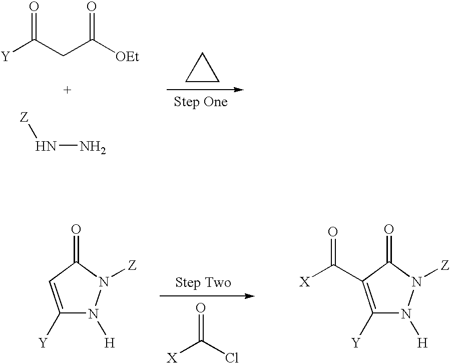

Alternatively the following reaction scheme can be used for step one:

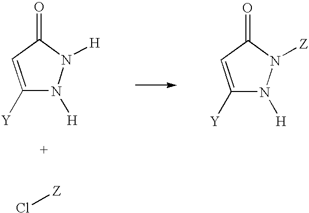

The first step can be carried out using heat in the presence of a solvent such as ethanol. The subsequent ring compound is then reacted with the desired acid chloride or anhydride, for example in the presence of calcium hydroxide and 1,4-dioxane.

The complex can be obtained by reacting the ligand with the lanthanide, for example as halide (LnX₃) or nitrate (Ln(NO₃)₃), in aqueous alcohol, in the presence of base. The co-ligand can be added either prior to addition of the lanthanide reagent, with the lanthanide reagent or after addition of the lanthanide reagent. Once the complex containing the co-ligand has been isolated, it can be heated under vacuum until the co-ligand has been evolved. The residue can then be further purified by sublimation/evaporation at reduced pressure to give the pure co-ligand free complex.

Alternatively, the complexes can be prepared in anhydrous conditions in a protonolysis reaction in which the substituted pyrazolone is reacted with a lanthanide compound. To be effective in this type of reaction, the lanthanide reagent must contain ligands that are readily protonated. Typical examples of suitable lanthanide reagents are lanthanide amides, alkyls, alkoxides and aryloxides. It will be appreciated that the substituted pyrazolone should be of comparable or greater acidity than the organic product of the protonolysis reaction. The protonolysis reaction is preferably carried out in non-coordinating aliphatic or aromatic hydrocarbon or chlorinated hydrocarbon solvents such as dichloromethane, hexane, benzene, toluene and chlorobenzene. In some cases the solvent and the organic reaction product can be removed under reduced pressure.

The compounds of the present invention are useful in light emitting devices. Accordingly, the present invention also provides an organic light emitting device which comprises a compound of the present invention. In its simplest form, an organic light emitting or electroluminescent device can be formed from a light emitting layer sandwiched between two electrodes at least one of which must be transparent to the emitted light. Typically, the device can be formed from a transparent substrate layer, a transparent electrode, a layer of light emitting material, and a second electrode. In a conventional structure the transparent electrode is the anode and the final electrode is the cathode. The transparent substrate is typically made of glass, but could be a transparent plastic such as PET. The transparent anode is preferably made from indium tin oxide (ITO), although other similar materials as well as conducting polymers such as PANI (polyaniline) may also be used. The cathode is generally made of a low work function metal or alloy such as Al, Ca, Mg, Li, or MgAg. As is well known, other layers may also be present, including a hole transporting material and/or an electron transporting material. In an alternative configuration, the substrate may be an opaque material such as silicon, and the light is emitted through the opposing electrode.

In one embodiment, the compounds of the present invention form a light emitting layer between the electrodes. A light emitting device can be formed with a single layer containing one or more compounds of this invention between the electrodes, but other layers may also be present. In particular there may be a hole transporting layer(s) between the anode and the light emitting layer and/or an electron transporting material between the light emitting layer and the cathode. Typical hole transporting materials include triarylamines such as TPD or -NPD, or PEDOT. Examples of electron transporting materials include oxadiazoles or aluminium tris(8-hydroxyquinolate). In addition there may be an electron injecting layer deposited before the cathode, suitable materials include LiF. Addition of suitable hole or electron transporting layers can improve the efficiency and/or lifetime of the device.

The layer comprising the compound of the present invention may consist of the compound or the compound can be doped into a host forming a blend. Typical host materials include a phosphorescent matrix such as a benzophenone or an acetophenone derivative, for example 1,1,1-triphenylacetophenone or 4,4′-dimethyloxybenzophenone, or a lanthanide complex whose ligand has a higher triplet energy than that of the complex of this invention, or an oxidazole such as 1,3-bis[5-(4-tert-butylphenyl)-[1,3,4]oxadiazol-2-yl]-benzene or a carbazole such as 4,4′-bis(carbazol-4-yl) biphenyl (CBP).

Devices containing the compounds of the invention can be prepared in a conventional manner. In a preferred embodiment the compounds are deposited on the substrate by physical vapour deposition (evaporation under reduced pressure).

The following Examples further illustrate the present invention.

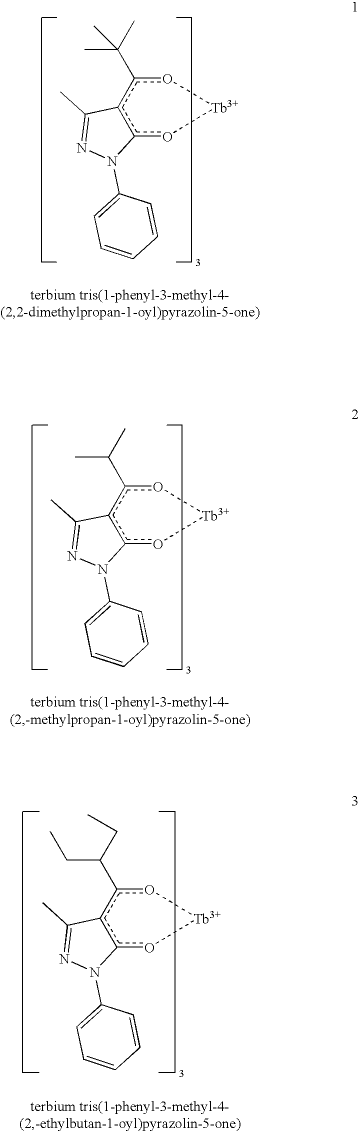

Synthesis of 1-phenyl-3-methyl-4-(2-ethylbutan-1-oyl)pyrazolin-5-one.

A mixture of 1-phenyl-3-methylpyrazolin-5-one (43.55 g, 250 mmoles) and 1,4-dioxane (300 cm³) was heated gently to 50° C. until the solid had fully dissolved. Calcium hydroxide (37.05 g, 500 mmoles) was then added and the reaction temperature was raised to 70° C. (±)-2-Methylbutyryl chloride (30.0 g, 270 mmoles) was then added slowly, so as to keep the reaction mixture at a gentle reflux. The reaction mixture was then kept at reflux for a further three hours and allowed to cool. The crude reaction mixture was poured into hydrochloric acid (3 M, 450 cm³), stirred vigorously and cooled to −25° C. overnight. The brown oil thus released was extracted into hexane (260 cm³), washed with hydrochloric acid (1 M, 10×100 cm³), dried over anhydrous magnesium sulphate and the solvent removed under vacuum. The crude mixture was dissolved in hexane (100 cm³) and extracted with aqueous potassium carbonate (1 M, 3×100 cm³). The combined aqueous layers were then washed with hexane (2×50 cm³) and acidified with concentrated hydrochloric acid. The yellow oil thus formed was extracted into hexane (100 cm³), dried over anhydrous magnesium sulphate and the solvent removed to give a yellow/orange oil. The crude product was then distilled under reduced pressure (oil-pump vacuum) at 154° C. to give 1-phenyl-3-methyl4-(2-ethylbutan-1-oyl)pyrazolin-5-one as a yellow oil (46.99 g, 73%).

Subsequent improvements to this procedure include the use of only 1.5 equivalents of calcium hydroxide. It was noticed that the reaction yield appears to be dependent on the steric size of the acid chloride used, with larger molecules (such as tert-butyl) giving reduced yields. This is ascribed to the greater activation energy required to form the desired C-acylated (thermodynamic) product compared with the O-acylated (kinetic) side-product.

1-phenyl-3-methyl-4-(2,2-dimethylpropan-1-oyl)pyrazolin-5-one; m.p. 91-92° C.; δH(500 MHz; CDCl₃) 1.41 (9H, s, tert-Bu), 2.65 (3H, s, Me), 7.32 (1H, t, J 7.5, 4′-H), 7.48 (2H, t, J 7.5, 3′,5′-H), 7.86 (2H, d, J 8, 2′, 6′-H), 14.92 (1H, s, pyrazolone).

1-phenyl-3-methyl-4-(2-methylpropan-1-oyl)pyrazolin-5-one; m.p. 61-62° C.; δH(500 MHz; CDCl₃) 1.29 (6H, d, J 5, iso-Pr CH₃), 2.52 (3H, s, Me), 3.19 (1H, m, iso-Pr H), 7.31 (1H, t, J 7.5, 4′-H), 7.47 (2H, t, J 7.5, 3′,5′-H, 7.86 (2H, d, J 10, 2′,6′-H), 13.5 (1H, br s, pyrazolone).

1-phenyl-3-methyl-4-(2-ethylbutan-1-oyl)pyrazolin-5-one; dH(500 MHz; CDCl₃) 0.97 (6H, t, J 7.5, 4″,2′″-H), 1.65 (2H, septet, J 7, alkyl H), 1.85 (2H, septet, J 7, alkyl H), 2.51 (3H, s, Me), 2.88 (1H, m, alkyl R₃C-H), 7.29 (1H, t, J 7.5, 4′-H), 7.47 (2H, t, J 7.5, 3′,5′-H), 7.89 (2H, d, J 10, 2′,6′-H), 14.0 (1H, br s, pyrazolone).

1-phenyl-3-methyl-4-(cyclohexylcarbonyl)pyrazolin-5-one; δH(500 MHz; CDCl₃) 1.27-1.45 (3H, m, cyclohexyl-H), 1.57-1.67 (2H, m, cyclohexyl-H), 1.76-1.82 (1H, m, cyclohexyl-H), 1.87-1.96 (4H, m, cyclohexyl-H), 2.51 (3H, s, Me), 2.87 (1H, m, R₂CHC(O)R), 7.30 (1H, t, J 7.5, 4′-H), 7.47 (2H, t, J 7.5, 3′,5′-H), 7.87 (2H, d, J 10, 2′,6′-H), 13.6 (1H, br s, pyrazolone).

1-phenyl-3-methyl-4-(heptafluorobutan-1-oyl)pyrazolin-5-one; δH(500 MHz; CDCl₃) 2.49 (3H, s, Me), 7.39 (1H, t, J 7.5, 4′′-H), 7.52 (2H, t, J 7.5, 3′,5′-H), 7.82 (2H, d, J 10, 2′,6′-H), 12.1 (1H, br s, pyrazolone).

Synthesis of terbium tris(1-phenyl-3-methyl-4-(2,2-dimethylpropan-1-oyl)pyrazolin-5-one).

A mixture of 1-phenyl-3-methyl4-(2,2-dimethylpropan-1-oyl)pyrazolin-5-one (10.000 g, 38.7 mmoles), sodium hydroxide (1.548 g, 38.7 mmoles) and 2,2′-dipyridyl (2.015 g, 12.9 mmoles) was stirred in a mixture of ethanol (450 cm³) and distilled water (500 cm³) until the solids had completely dissolved. A solution of terbium chloride hexahydrate (4.818 g, 12.9 mmoles) in distilled water (50 cm³) was then added dropwise. The reaction mixture was stirred at room temperature for 1 hour and the white precipitate was then filtered and dried under suction. A portion (10.000 g) of this crude material (15.78 g) was heated under vacuum (7×10⁻⁷ mbar) at 200° C. for 30 minutes and then at 220° C. for 30 minutes until no more 2,2′-dipyridyl was evolved. The residue was then sublimed (280-320° C., 7×10⁻⁷ mbar), filtering through glass wool. The purified material was then sublimed twice more (290° C., 7×10⁻⁷ mbar) to give a white solid (5.508 g, 72%).

1) Terbium tris(1-phenyl-3-methyl-4-(2,2-dimethylpropan-1-oyl)pyrazolin-5-one).

Found: C, 57.87%; H, 5.51%; N, 8.99%. C₄₅H₅₁N₆O₆Tb requires C, 58.06%; H, 5.52%; N, 9.03%.

Europium tris(1-phenyl-3-methyl-4-(2,2-dimethylpropan-1-oyl)pyrazolin-5-one).

Found: C, 58.48%; H, 5.75%; N, 9.11%. C₄₅H₅₁EuN₆O₆ requires C, 58.50%; H, 5.56%; N, 9.10%. (not luminescent)

Gadolinium tris(1-phenyl-3-methyl-4-(2,2-dimethylpropan-1-oyl)pyrazolin-5-one).

Found: C, 58.13%; H, 5.59%; N, 9.05%. C45H51GdN6O6 requires C, 58.17%; H, 5.53%; N, 9.04%. (not luminescent)

Dysprosium tris(1-phenyl-3-methyl-4-(2,2-dimethylpropan-1-oyl)pyrazolin-5-one).

Found: C, 57.81%; H, 5.36%; N, 9.15%. C₄₅H₅₁DyN₆O₆ requires C, 57.84%; H, 5.50%; N, 8.99%.

3) Terbium tris(1-phenyl-3-methyl-4-(2-ethylbutan-1-oyl)pyrazolin-5-one).

Found: C, 59.23%; H, 5.71%; N, 8.39%. C₄₈H₅₇N₆O₆Tb requires C, 59.26%; H, 5.91%; N, 8.64%.

4) Terbium tris(1-phenyl-3-methyl-4-cyclohexylcarbonylpyrazolin-5-one).

Found: C, 60.68%; H, 5.68%; N, 8.36%. C₅₁H₅₇N₆O₆Tb requires C, 60.71%; H, 5.69%; N, 8.33%.

5) Terbium tris(1-phenyl-3-methyl-4-(3,3-dimethylbutan-1-oyl)pyrazolin-5-one)

Found: C, 58.97%; H, 5.79%; N, 8.44%. C₄₈H₅₇N₆O₆Tb requires C, 59.26%; H, 5.91%; N, 8.64%.

Synthesis of 1-phenyl-3-methyl-4-(2,2,-dimethylpropan-1-oyl)pyrazolin-5-one:

A mixture of 1-phenyl-3-methyl4-(2,2-dimethylpropan-1-oyl)pyrazolin-5-one (24 g, 0.14 mol) and 1,4-dioxane (600 ml) was heated at 70° C. for 10 minutes in a 11 flask equipped with a mechanical stirrer, to give a yellow solution. Calcium hydroxide (30 g, 0.41 mol) was added to the solution in small portions over a 10-minute period. The resulting pink coloured mixture was allowed to cool to room temperature and then trimethylacetyl chloride (21 g, 0.17 mol) was added dropwise over 30 minutes. The resulting mixture was heated to reflux whereupon the mixture became paler and considerably more viscous. The reaction was maintained at reflux for a further 18 hours. The cloudy pinkish mixture was cooled to room temperature and poured into a stirred solution of ice-cold hydrochloric acid (1200 ml, 3 mol). The mixture immediately changed colour to pale brown, became cloudy and effervesced. Within 90 minutes a significant amount of solid had begun to precipitate and the solution became clearer. Stirring was continued for a further 15 hours. The pink/brown solid was isolated by vacuum filtration and dried under vacuum to give 11 g of a tan solid. Sublimation (95° C., approximately 10⁻⁶ bar), of this product (4.6 g) gave the product, 1-phenyl-3-methyl-4-(2,2-dimethylpropan-1-oyl)pyrazolin-5-one, as a pale yellow solid (3.2 g, 21% yield). ¹H NMR data was as above.

Preparation of EL Devices

0.4 mm thick glass sheets coated with 100 nm of ITO are scribed into 4×4 inch (102 mm×102 mm) substrates. These substrates are spin-cast with photo-resist and, after drying, covered with a photolithographic mask, and exposed to an UV radiation source. The mask defines 4 electrodes, which will each form a device with a light emitting area of 16 mm×27 mm. The virtual image is fixed by treating the device with a developing agent which dissolves the exposed areas of the photo-resist film. After rinsing in deionised water, hydrobromic acid is used to etch the uncovered areas of ITO. Finally the remaining photo-resist is removed by a standard removing agent. The so prepared substrates are cleaned in an ultrasonic bath in a detergent solution, rinsed, then kept in an oven at 90° C.

The ITO glass substrates undergo a final dry oxygen plasma clean at a power of 60 watts for 4 minutes just prior to evaporation. All subsequent OLED device preparation processes are carried out under nitrogen atmosphere or under vacuum. Chemicals and evaporation equipment are usually stored under nitrogen. After plasma cleaning the substrate is masked and placed in an evaporator where the pressure is reduced to below 10⁻⁶ mbar. The organic materials are all evaporated from boron nitride crucibles which are heated externally. The organic materials used in the Examples are α-NPD (N,N′-bis(napthalen-2-yl)-N,N′-bis(phenyl)benzidine), Alq₃ (tris (8-hydroxyquinoline) aluminium) and the complexes 1, 3, and terbium tris(1-phenyl-3-methyl-4-cyclohexylacetylpyrazolin-5-one) (4), terbium tris(1-phenyl-3-methyl-4-(3,3-dimethylbutan-1-oyl)pyrazolin-5-one) (5), and terbium tris(1-phenyl-3-methyl-4-(±2-methylbutan-1-oyl)pyrazolin-5-one) (6).

All organic materials are evaporated at an average evaporation rate of 0.05 nms⁻¹. The evaporation pressure varies in all cases between 2.0 and 9.0×10⁻⁷ mbar and is dependent on temperature (between 170 and 240° C.) and initial pressure. The desired organic layers are evaporated sequentially. The mask is then changed to form a cathode with a connection pad and no direct shorting routes. The cathode is deposited by evaporating 100 nm of aluminium at a rate of 0.1 nm/s. For some of the example devices, 1.5 nm of LiF was deposited (evaporated at a rate of 0.02 nm/s) before the aluminium was put down.

EL measurements were made under forward bias (ITO positive) and the emission output was viewed in the forward direction through the transparent ITO electrode. Reported device results are from tests carried out under ambient conditions, with no encapsulation. Obviously, the devices can be encapsulated to increase the shelf life. The current voltage and luminence (I-V-L) characteristics were measured with a Keithley 2400 source-measure unit and a Minolta LS100 photometer. The EL spectra were measured using a L.O.T. Oriel open electrode CCD imaging spectrograph. The lifetime data was recorded using computer controlled Keithley electrometers.

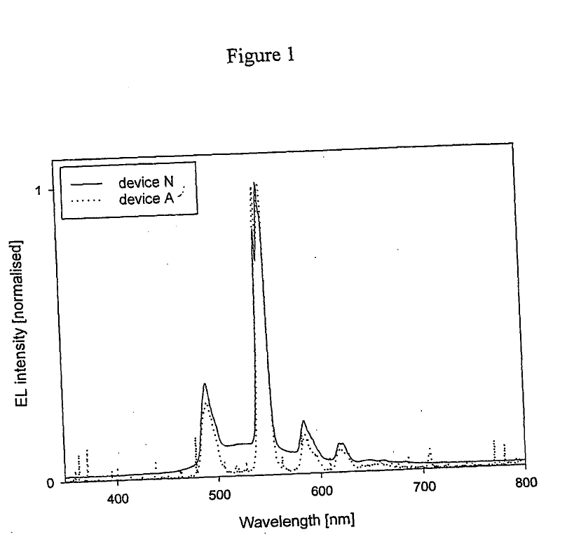

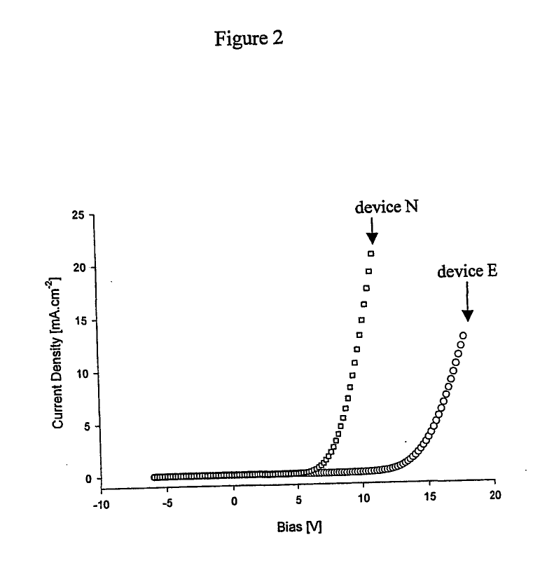

Green EL emission, with the characteristic Tb emission spectrum, was seen from all the single layer devices (A-F) (see FIG. 1). However the efficiency of the device was generally higher if a hole and/or electron transporting layer was also present (compare Table 1 and Table 2) and see FIG. 2 which shows the IV characteristics of device E (circles) and device N (squares). Devices containing 3 are more efficient than equivalent devices containing 1. In the emission spectrum from device N containing 3 and Alq₃ (FIG. 1), there is a small contribution from Alq3 but the dominant component is the Tb emission peaks. The unencapsulated lifetime of the device N, when measured under constant current stress of 0.5 mA/cm², is 8 hrs to half brightness.

TABLE 1
EL efficiency of various monolayer devices

| Device | Device Structure | L/W | cd/A |
|---|---|---|---|
| A | ITO/1/Al (70 nm) | 0.0035 | 0.014 |
| B | ITO/4/Al (70 nm) | 0.02 | 0.084 |
| C | ITO/6/Al (70 nm) | 0.02 | 0.09 |
| D | ITO/1/LiF/Al (70 nm) | 0.002 | 0.01 |
| E | ITO/3/LiF/Al (70 nm) | 0.05 | 0.2 |
| F | ITO/5/LiF/Al (70 nm) | 0.01 | 0.53 |

The numbers in brackets are the film thickness in nanometers. The efficiency measurements were recorded at 1 mA/cm².

TABLE 2
EL efficiency of various bilayer and trilayer devices

| Device | Device Structure | L/W | cd/A |
|---|---|---|---|
| G | ITO/1/Alq₃/Al (70 nm) (20 nm) | 0.1 | 0.32 |
| H | ITO/4/Alq₃/Al (70 nm) (20 nm) | 0.12 | 0.5 |
| I | ITO/1/Alq₃/LiF/Al (70 nm) (20 nm) | 0.27 | 0.8 |
| J | ITO/3/Alq₃/LiF/Al (70 nm) (20 nm) | 0.54 | 1.9 |
| K | ITO/5/Alq₃/LiF/Al (50 nm) (20 nm) | 0.43 | 1.1 |
| L | ITO/α-NPD/1/Alq₃/LiF/Al | 0.67 | |
| | (40 nm) (18 nm) (30 nm) | | |
| M | ITO/α-NPD/5/Alq₃/LiF/Al | 0.22 | 0.58 |
| | (25 nm) (30 nm) (20 nm) | | |
| N | ITO/α-NPD/3/Alq₃/LiF/Al | 1.1 | 2.5 |
| | (40 nm) (20 nm) (20 nm) | | |

The efficiency measurements were recorded at 1 mA/cm².

1. A compound of the formula: 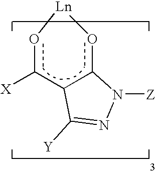
in which Ln represents a trivalent lanthanide ion, each of X, Y and Z, which may be the same or different, represents hydrogen, an optionally substituted aromatic group or an optionally substituted aliphatic or cycloaliphatic group, such that at least one of X, Y and Z represents a said aromatic group which is conjugated with the pyrazolone ring system and such that when X or Y represents a said group, said group can optionally be attached via a hetero atom.

2. A compound according to claim 1 which contains 1 or 2 said aromatic conjugated groups.

3. A compound according to claim 1 or 2 wherein Z represents a said aromatic conjugated group.

4. A compound according to any one of claims 1 to 3 wherein said aromatic group is optionally substituted phenyl.

5. A compound according to any one of the preceding claims wherein at least one of X, Y and Z is a said aliphatic or cycloaliphatic group.

6. A compound according to any one of claims 3 to 5 wherein at least one of X and Y is a said aliphatic or cycloaliphatic group.

7. A compound according to claim 6 wherein one of X and Y is an alkyl group of 1 to 4 carbon atoms and the other is an alkyl group of at least 4 carbon atoms or an aryl group.

8. A compound according to claim 7 wherein the alkyl group of 1 to 4 carbon atoms is methyl

9. A compound according to claim 7 or 8 wherein the alkyl group of at least 4 carbon atoms either possesses 2 branches at the 1-position or 2 or 3 branches further down the chain.

10. A compound according to claim 9 wherein said alkyl group is 3-pentyl.

11. A compound according to any one of the preceding claims wherein Ln is terbium or dysprosium.

12. A compound according to any one of the preceding claims which is substantially free of a corresponding compound which possesses a co-ligand.

13. A compound according to claim 1 specifically identified herein.

14. A process for preparing a compound as claimed in any one of the preceding claims which comprises subliming at least once a corresponding compound which possesses a co-ligand.

15. A process according to claim 14 wherein the co-ligand is 2,2′-bipyridyl.

16. A process according to claim 14 or 15 wherein the, or the last, sublimation takes place directly onto a substrate forming one layer of a light emitting device.

17. A process according to claim 14 substantially as described in any one of the Examples.

18. A compound as defined in any one of claims 1 to 13 whenever prepared by a process as claimed in any one of claims 14 to 17.

19. A light emitting device which comprises a compound as claimed in any one of claims 1 to 13 and 18.

20. A device according to claim 19 which comprises a transparent substrate layer, a transparent electrode, a layer of light emitting material and a second electrode, said light emitting material comprising said compound.

21. A light emitting device according to claim 19 substantially as hereinbefore described.
